(19) United States
(12) Patent Application Publication
(10) Pub. No.: US 2009/0060860 A1
(43) Pub. Date: Mar. 5, 2009

(54) BETA-CYCLODEXTRINS AS NUCLEATING AGENTS FOR POLY(LACTIC ACID)

(76) Inventors: Eva Almenar, East Lansing, MI (US); Rafael Auras, Lansing, MI (US); Bruce Harte, Bath, MI (US); Maria Rubino, East Lansing, MI (US)

Correspondence Address: HOWARD & HOWARD ATTORNEYS PLLC, 450 West Fourth Street, Royal Oak, MI, 48067, US

(21) Appl. No.: 12/201,452

(22) Filed: Aug. 29, 2008

Related U.S. Application Data
(60) Provisional application No. 60/969,273, filed on Aug. 31, 2007.

(51) Int. Cl. A01N 37/00

(52) U.S. Cl. 424/78.37

(57) ABSTRACT

The use of β-CDs as nucleating agents for PLA to provide an increase in polymer crystallinity is described. The improvement in increased crystallinity is related to the percentage of β-CDs used. For the analyzed films, crystallinity was approximately 1.47% in the absence of a nucleating agent, and approximately 17.85% in the presence of the maximum amount of nucleating agent tested (e.g., 30%). Thus, improvement in processability, producability, and heat resistance of PLA will depend on the amount of β-CDs loaded. Additionally, loading PLA with β-CDs carrying an antifungal volatile is an effective way to increase PLA crystallinity besides avoiding fungal development when used in active packaging. In this case, the antifungal volatiles, along with changes in headspace concentration because of changes in crystallinity, may prolong the fresh produce shelf life.

### CROSS-REFERENCE TO RELATED APPLICATION

The instant application claims priority to U.S. Provisional Patent Application Ser. No. 60/969,273, filed Aug. 31, 2007, the entire specification of which is expressly incorporated herein by reference.

### BACKGROUND OF THE INVENTION

1. Field of the Invention

The present invention generally relates to systems for preventing post harvest fungal diseases of produce and more specifically to films and packaging materials (including those that are biodegradable and non-biodegradable) incorporating β-cyclodextrins as nucleating agents for poly(lactic acid)-containing materials. Additionally, these β-cyclodextrins can incorporate anti-microbial materials, such as encapsulated anti-fungal substances, for preventing post harvest fungal diseases of fresh produce.

2. Description of the Related Art

Fresh produce are perishable items with a relatively short lifespan. High levels of sugars and other nutrients, along with an ideal water activity and low pH, provide a growth medium for various microorganisms, including fungi. Post harvest losses during fresh produce storage and marketing are mainly caused by fungi such as Colletotrichum acutatum, Alternaria alternata and Botrytis cinerea. Other species of fungi that produce various post harvest diseases in fresh produce include Gliocephalotrichum microchlamydosporum, Colletotrichum gloeosporioides, Botryodiplodia theobromae, and Rhizopus stolonifer.

Additionally, Penicillium roqueforti, Penicillium expansum, and Aspergillus niger are also common contaminants of various food systems, including fresh produce. These fungi typically grow at moisture content of 15 to 20% in equilibrium with a relative humidity of 65 to 90% and temperatures up to 55° C. They are harsher when temperatures surpass 25° C. and relative humidity goes above 85%.

Control of these organisms is very difficult, even with preharvest fungicidal application. Alternative means for reducing or avoiding fungal growth in fresh produce are being studied, and one of these is the use within their environment of natural occurring plant volatiles well known for their anti-fungal effectiveness. Recently, interest in these natural substances has increased and numerous studies on their anti-fungal activity have been reported. Aroma (i.e., volatile) compounds such as hexanal, acetaldehyde, and 2E-hexenal have shown antimicrobial activity against spoilage microbial species in in vivo. However, the main disadvantages include their volatility and premature release from the application point. That is, these volatile gaseous materials have a tendency to rapidly dissipate into the atmosphere and thus reduce their effectiveness.

Therefore, it would be advantageous to provide new and improved systems for reducing or preventing fungal growth in food systems, such as but not limited to fresh produce, which overcome at least one of the aforementioned problems.

### SUMMARY OF THE INVENTION

In accordance with the general teachings of the present invention, the utilization of β-cyclodextrins (β-CDs) as new nucleating agents for poly(lactic acid) (PLA) is provided. In accordance with one aspect of the present invention, an increase of PLA crystallinity can be achieved by using β-CDs or inclusion complexes (ICs) β-CDs-antimicrobial volatiles. In accordance with another aspect of the present invention, PLA blends (PLA+β-CDs or ICs β-cyclodextrins-antimicrobial volatile) in which barrier, physical and mechanical PLA properties are modified depending on the percentage of β-CDs inserted have been developed. In accordance with another aspect of the present invention, the presence of antimicrobial volatiles inside β-CDs, that is, when used ICs β-CDs-antimicrobial volatile, does not modify the nucleating capacity of the β-CDs for PLA.

In accordance with one aspect of the present invention, β-cyclodextrins have been shown to be effective nucleating agents for poly(lactic acid) (PLA) because studies of thermal characterization using a DSC showed that PLA crystallinity was increased when the polymer was loaded with β-CD. The increase was proportional to the amount of compound loaded into the biodegradable polymer. β-cyclodextrins carrying an antifungal volatile such as but not limited to 2E-Hexenal, that is inclusion complex β-CDs-antimicrobial volatiles, are also shown as effective nucleating agents for PLA. Therefore, the presence of antimicrobial volatiles inside β-CDs does not modify the nucleating capacity of the β-CDs for PLA.

Further areas of applicability of the present invention will become apparent from the detailed description provided hereinafter. It should be understood that the detailed description and specific examples, while indicating the preferred embodiment of the invention, are intended for purpose of illustration only and are not intended to limit the scope of the invention.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1a is a graphical view of the increase of PLA crystallinity by using β-CDs (with or without antifungal volatiles) as nucleating agents, in accordance with the general teachings of the present invention;

FIG. 1b is a graphical view of the increase of PET crystallinity by using β-CDs (with or without antifungal volatiles) as nucleating agents, in accordance with the general teachings of the present invention;

FIG. 2 is a photographical view of the transparency of a PLA sheet produced in accordance with the present invention;

FIG. 3 is a photographical view of a comparison among a conventional PLA sheet and two PLA sheets produced in accordance with the present invention with different percentages of β-CD (note: all the sheets look cloudy due to the black background); and

FIG. 4 is a graphical view of the heat deflection temperature curves of two samples of PLA, one containing β-CDs and the other containing ICs, in accordance with the general teachings of the present invention.

The same reference numerals refer to the same parts throughout the various Figures.

### DETAILED DESCRIPTION OF THE INVENTION

The following description of the preferred embodiment(s) is merely exemplary in nature and is in no way intended to limit the invention, or uses.

The crystallization process consists of two major events, nucleation and crystal growth. Nucleation is the step where the solute molecules dispersed in the solvent start to gather into clusters, on the nanometer scale (elevating solute concentration in a small region), that becomes stable under the current operating conditions. These stable clusters constitute the nuclei. However, when the clusters are not stable, they redissolve. Therefore, the clusters need to reach a critical size in order to become stable nuclei. Such critical size is dictated by the operating conditions (e.g., temperature, supersaturation, and/or the like). It is at the stage of nucleation that the atoms arrange in a defined and periodic manner that defines the crystal structure (“crystal structure” is a phrase that refers to the relative arrangement of the atoms, not the macroscopic properties of the crystal (e.g., size and shape), although those are a result of the internal crystal structure).

The crystal growth is the subsequent growth of the nuclei that succeed in achieving the critical cluster size. Nucleation and growth continue to occur simultaneously while the supersaturation exists. Supersaturation is the driving force of the crystallization, hence the rate of nucleation and growth is driven by the existing supersaturation in the solution. Depending upon the conditions, either nucleation or growth may be predominant over the other, and as a result, crystals with different sizes and shapes are obtained. Once the supersaturation is exhausted, the solid-liquid system reaches equilibrium and the crystallization is complete, unless the operating conditions are modified from equilibrium so as to supersaturate the solution again.

The rate of crystallization and the degree of crystallinity of semicrystalline polymers are one Of the most important properties in order to increase the mechanical strength and thermal resistance of plastics. Crystallinity strongly affects the processability and productivity of mold processing and performance of molded articles. Controlling crystallization factors allow for the design of materials with desirable properties. The most available method to increase nucleation density and thus the overall crystallization rate is the addition of nucleating agents. Several compounds such as talc, calcium lactate, EBHSA (i.e., ethylenebis (12-hydroxystearylamide)), lactide, indigo, benzoylhydrazide-type compounds, silica, kaolonite, polyglycolic acid, and/or the like are being used as nucleating agents for PLA. So far, talc is considered the best nucleating agent. However, there are some limitations in utilizing the above-mentioned compounds, for instance: (1) indigo coloring the polymeric material; (2) low weight percentages (e.g., 1%) of such solid nucleating agents into the thermoplastic composition are necessary to avoid their agglomeration and as a result the blocking of filters and spinneret holes during processing; (3) decrease in transparency (e.g., cloudy material) - for instance, by adding 5% by weight of calcium lactate as a nucleating agent to an L- and DL-lactide copolymer; and (4) slow crystallization velocity and insufficient crystallinity for talc, silica and kaolinite.

The present invention overcomes the aforementioned deficiencies in the prior art by: (1) utilization of β-cyclodextrins (β-CDs), with the absence or presence of inclusion complexes (ICs) including antimicrobial volatiles, as new nucleating agents (increase of polymeric crystallinity) for poly(lactic acid) (PLA); (2) development of PLA blends (e.g., PLA+β-CDs or ICs β-cyclodextrins-antimicrobial volatile) in which PLA barrier, physical and mechanical properties are modified depending on the percentage of β-CDs inserted; and (3) the presence of antimicrobial volatiles inside β-CDs, that is, when used as ICs β-CDs-antimicrobial volatiles, do not modify the nucleating capacity of the β-CDs for PLA.

Cyclodextrins (CDs) are naturally occurring molecules (produced enzymatically from starch) composed of glucose units arranged in a bucket shape with a central cavity. These oligosaccharides are composed of six, seven and eight anhydroglucose units, namely α, β and γ, respectively. All have a hydrophilic exterior and a hydrophobic cavity, which enables them to form inclusion complexes (IC) with a variety of hydrophobic molecules. The various cavity sizes allow for great application flexibility because ingredients with different molecular sizes can be effectively complexed. Thus, acetaldehyde and hexanal have been microencapsulated in cyclodextrins to prevent premature release and so to allow slow diffusion over a long period of time. Both ICs have been mixed with polylactic acid (PLA) resin (e.g., a biodegradable polymer) to form active polymer sheets. It should be noted that these biodegradable materials can be shaped into films, packaging (e.g., containers, lids and/or the like), and/or the like. The effectiveness of these active films was then tested on fresh produce pathogens, including but not limited to berry pathogens.

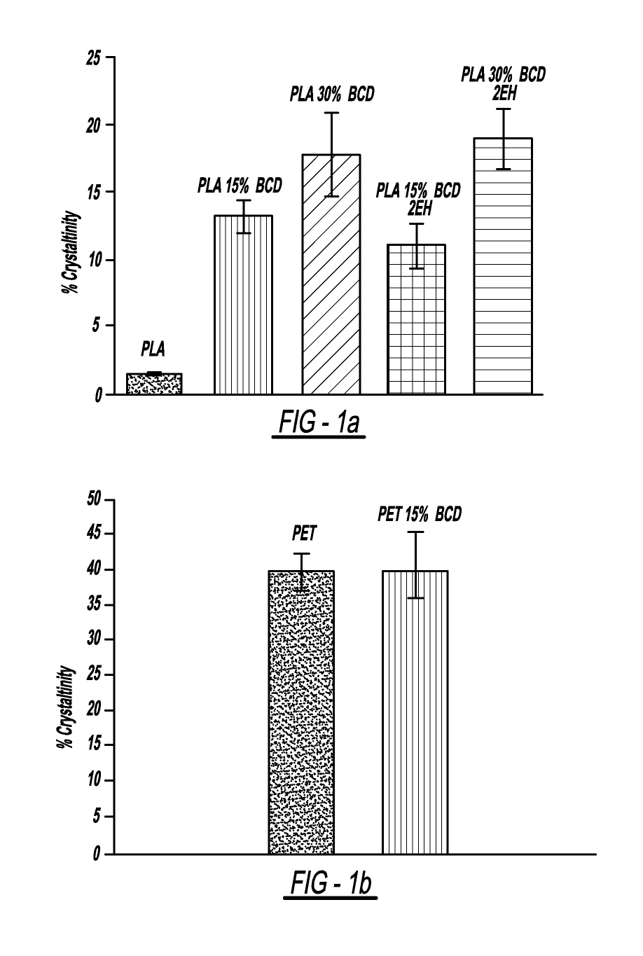

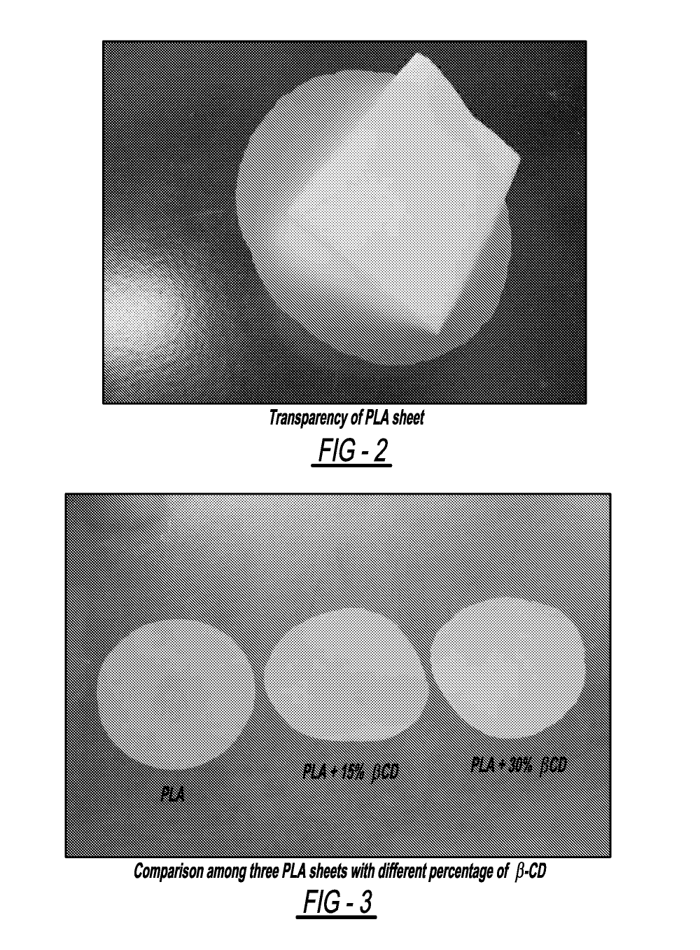

The use of β-CDs as nucleating agent for PLA opens a new way to increase crystallinity. The improvement is related to the percentage of β-CDs used. For the analyzed films, crystallinity was approximately 1.47% in the absence of a nucleating agent, and approximately 17.85% in the presence of the maximum amount of nucleating agent as shown in FIG. 1a (FIG. 1b shows that the addition of β-CDs to a conventional polymer, PET, did not significantly increase the crystallinity thereof). By way of a non-limiting example, the crystalline polymeric material has a degree of crystallinity in the range of about 1.5% to about 18%. Thus, improvements in processability, producability and heat resistance of PLA will depend on the amount of β-CDs loaded. Also, loading PLA with β-CDs carrying an antifungal volatile is an effective way to increase PLA crystallinity. Thus, these new films will be able to avoid fungal development used in active packaging due to both antifungal volatiles plus changes in headspace concentration because of changes in crystallinity. In addition, β-CDs do not color the PLA as shown in FIGS. 2 and 3 and transparency of the polymer is maintained (e.g., see FIG. 2). Also, high percentages of β-CDs can be processed because any problem during processing was observed in the extruder when it was loaded with β-CDs up to 30%.

Therefore, using β-CDs as nucleating agents is another way to improve processability, productivity, and heat resistance of PLA. In addition, β-CDs would be able to introduce into the PLA polymers antimicrobial materials in such a way that a biodegradable antimicrobial film can be developed.

Because both β-CDs and PLA are accepted for food contact, newly developed films/containers will be completely acceptable for food contact. In addition, improvements in processability, productivity, and heat resistance during processing can be achieved with the present invention. In addition, as mentioned before, β-CDs do not affect the color of PLA or its transparency.

On the other hand, a totally environmentally friendly film will be developed because both β-CDs and poly(lactic acid) are starch-based products.

An example of the synthesis of β-CD-2E-Hexenal inclusion complexes of the present invention is presented herewith in Example I, below:

### EXAMPLE I

A cyclodextrin/water solution (1:1 molar) was prepared by adding β-cyclodextrins to a beaker containing hot distilled water (100° C.) and stirring at 225 rpm using a hot plate stirrer (Thermolyne® Mirak™ hot plate/stirrer; Sigma-Aldrich Corp., Saint Louis, Mo.). An amount of 315 μl of 2E-hexenal was slowly released into the solution and then stirred for two hours. After that, the beaker was transferred to a new stirrer plate (Thermolyne Nuova II Stir Plate, Bamstead International, Testware, Sparks, Nev.) for thirty minutes at room temperature. Finally, the sample was centrifuged at 1600 rpm for one hour and the precipitate obtained was dried at 60° C. overnight. All samples were kept in hermetically sealed flasks at 23° C.

An example of the measurement of the emission of hexanal from the inclusion complexes of the present invention is presented herewith in Example II, below:

### EXAMPLE II

A simple desorption system was used to evaluate the efficacy of the ICs (e.g., see Almenar, E.; Auras, R.; Rubino, M.; and Harte, B., “A new technique to prevent main postharvest diseases in berries during storage: inclusion complexes β-CD-hexanal, Int. J. Food Microbiol., (2007)). Glass vials ( 40 mL) were filled with 1 ml of distilled water and on the bottom of these a 2-mL glass vial containing 0.1 g of inclusion complex was positioned. Vials were immediately closed with Mininert® valves (Supelco, Bellefonte, Pa.). After 24 hours, hexanal concentrations released from the IC to the vial headspaces were measured using a 65-μm DVB/CAR/PDMS SPME fiber (Supelco, Bellefonte, Pa.) and a Hewlett-Packard 6890 Gas Chromatograph (Agilent Technology, Palo Alto, Calif.) equipped with FID and a HP-5 column (30 m×0.32 mm×0.25 μm). The fiber was exposed to the vial headspace for 10 minutes. The volatiles trapped in the SPME were quantified by desorbing the volatile (for 5 minutes) at the splitless injection port of the GC. The oven temperature was initially 40° C. for 5 minutes and afterwards increased to 230° C. at 5° C./minute and maintained for 10 minutes. The injector and detector temperatures were set at 220 and 230° C., respectively. Quantification of hexanal in the headspace was determined using previously prepared calibration curves. Three replicates were evaluated for each IC sample, the analysis being carried out at room temperature.

An example of the development of the polymeric sheets of the present invention is presented herewith in Example III, below:

### EXAMPLE III

PLA was dried overnight at 60° C. The polymeric material and β-CD or ICs were weighed as per the calculated compositions (e.g., see Table I below) and mixed together and fed to the extruder barrel of a micro twin screw extruder equipped with an injection molder system (TS/I-02, DSM, The Netherlands). The temperature of the three zones of the extruder was 186° C. PLA was melted at 180° C. and then all the compounds were mixed at 100 rpm for 2 minutes. The mini-extruder was equipped with co-rotating screws having lengths of 150 mm, with L/D radio of 18 and net capacity 15 cm³. After extrusion, the materials were transferred through a preheated cylinder (180° C.) to the mini injection molder (40° C.) to prepare bar- and disk-shaped specimens for various analyses. The attached injection molding unit was capable of 120 psi injection force.

TABLE I
Sample codes of PLA and its blends

| Sample Code | Polymer (%) | β-CDs (%) | Antifungal volatile |
|---|---|---|---|
| PLA | 100 | 0 | None |
| PLA 15% BCD | 85 | 15 | None |
| PLA 30% BCD | 70 | 30 | None |
| PLA 15% BCD2EH | 85 | 15 | 2E-hexenal |
| PLA 30% BCD2EH | 70 | 30 | 2E-hexenal |

An example of the study of the crystallinity of the polymeric sheets of the present invention is presented herewith. Thermal characterization of the different blends was carried out using a TA Instruments Q100 V 9.8 Differential Scanning Calorimeter (TA Instruments, New Castle, Del.). The temperature calibration of equipment was performed in accordance with ASTM E967-03 (e.g., see ASTM (2003), ASTM E967-03, Standard Practice for Temperature Calibration of Differential Scanning Calorimeters and Differential Thermal Analyzers, Annual Book of ASTM Standards, Vol. 14.02) and the heat flow calibration was performed in accordance with ASTM E968-02 (e.g., see ASTM (2002), ASTM E968-02, Standard Practice for Heat Flow Calibration of Differential Scanning Calorimeters, Annual Book of ASTM Standards, Vol. 14.02). Transition glass temperature, melting temperature, enthalpies of fusion and crystallinity were measured and calculated in accordance with ASTM D3418-03 (e.g., see ASTM (2003), ASTM D3418-03, Standard Test Method for Transition Temperatures and Enthalpies of Fusion and Crystallization of Polymers by Differential Scanning Calorimetry, Annual Book of ASTM Standards, Vol. 08.02). The degree of crystallinity (%) was calculated as follows:

$$\% {χ}_{c} = ( \frac{Δ {H}_{r} + Δ {H}_{m} - Δ {H}_{c}}{93} ) \times 100$$

wherein ΔHᵣ, ΔHₘ and ΔH_{c} indicate relaxation enthalpy, melting enthalpy and crystallization enthalpy, respectively. A value of 93 J/g was used because it has been reported as the melting enthalpy for 100% crystalline PLA (e.g., see Fischer, E. W.; Sterzel, H. J.; and Wegner, G., “Investigation of the structure of solution grown crystals of lactide copolymers by means of chemical reactions,” Colloid & Polymer, 251(11), 980-990 (1973)).

An amount between 9-10 g was used for each experiment. Samples were heated from room temperature to 190° C. with a heating rate of 10° C./minute, and then cooling down to −60° C. and again warming up to 190° C. using same heating rate. Three replications of each type of film were tested.

Structural, mechanical and physical characterization of the obtained polymers was conducted in order to compare with commercial materials.

The materials used were as follows. PLA, PS and PET resins (Wilkinson Industries, Inc., Fort Calhoun, Nebr.); β-cyclodextrins (>99%) (β-CDs) (Wacker Chemical Corporation, Adrian, Mich.); 2E-hexenal (>95%, Food grade) (Sigma-Aldrich Corp., Saint Louis, Mo.); high purity gases N₂, CO₂, (Linde Gas, LLC, (Independence, Ohio); and compressed O₂ (Aga Specialty Gas, Inc., (Cleveland, Ohio).

The synthesis of the β-CD-2E-Hexenal Inclusion Complexes (ICs) was carried out as follows. A β-CDs /water solution (1:1 M) was prepared by using co-precipitation technique. The antifungal volatile 2E-hexenal was slowly released into the solution and then that stirred during several hours. Finally, the sample was centrifuged and the precipitate obtained was dried overnight. All samples were kept in hermetically sealed flasks at 23° C. still those being used.

A sample was prepared as follows. The polymeric material and β-CDs or ICs were weighed as per the calculated compositions (see Table II) and mixed together and fed to the extruder barrel of a micro twin screw extruder equipped with an Injection molder system (TS/I-02, DSM, The Netherlands).

TABLE II

| Sample Code | Polymer (%) | β-CDs (%) | Antifungal volatile |
|---|---|---|---|
| PET | 100 | 0 | None |
| PET 15% BCD | 85 | 15 | None |
| PS | 100 | 0 | None |
| PS 15% BCD | 85 | 15 | None |
| PLA | 100 | 0 | None |
| PLA 15% BCD | 85 | 15 | None |
| PLA 30% BCD | 70 | 30 | None |
| PLA 15% BCD2EH | 85 | 15 | 2E-hexenal |
| PLA 30% BCD2EH | 70 | 30 | 2E-hexenal |

After extrusion, the materials were transferred through a preheated cylinder to the mini injection molder to prepare bar- and disk-shaped specimens for various analyses.

The barrier measurements were conducted as follows. The disk-shaped specimens were melted and pressed into films using a hydraulic press (Hydraulic unit model #3925, Caver Laboratory equipment, Wabash, Ind.). The films thickness (5-10 films) was measured using a TMI 549M micrometer (Testing Machines, Inc., Amityville, N.Y.) according to ASTM D374-99. The water vapor transmission rates (WVTR) were measured in accordance to ASTM F1249·06 (4) using a Permatran W Model 3/33 Water Permeability Analyzer (Mocon, Minneapolis, Minn.) at 37.8° C. and 100% RH). The CO₂ transmission rates (CO2TR) were measured in accordance to ASTM F2476-05 using a Permatran CTM Model 4/41 (Mocon, Minneapolis, Minn.) at 23° C. and 0% RH. The oxygen transmission rates (OTR) were measured in accordance to ASTM D3985-05 using an 8001 Oxygen Permeation Analyzer (Mocon, Minneapolis, Minn.) at 23° C. and 0% RH. In all cases, the films area analyzed was 2.54 cm².

The mechanical properties of the films were measured as follows. DMA was carried out using a TA Instruments Model Q 800 dynamic mechanical analyzer to characterize and to compare the viscoelastic nature of the blends against plain polymers. Storage modulus (E′) and loss modulus (E″) were measured as a function of temperature in accordance to ASTM D4065-06. The analyzer was a equipped a single cantilever fixture. The heat deflection temperature (HDT) was determined using a double cantilever. All specimens were injection-molded and were approximately 17.50 mm long, 12.03 mm wide, and 2.00 mm thick.

The study of the physical properties was carried out as follows. Thermal characterization of both blends and plain polymers was carried out using a TA Instruments Q100 V 9.8 Differential Scanning Calorimeter (TA Instruments, New Castle, Del.). Transition glass temperature, melting temperature, enthalpies of fusion and crystallinity were measured and calculated in accordance with ASTM D3418-03. Degree of crystallinity (%) was calculated as follows: % Xc=((ΔHr+ΔHm-ΔHc)/93)*100. A value of 93 J/g was used because it has been reported as melting enthalpy for 100% crystalline PLA.

The statistical analysis was carried out as follows. MINITAB Statistical Software, Release 14 for Windows (Minitab, Inc., State College, Pa.) was used for analysis of variance (ANOVA) statistical comparison and to test significant differences between means with p 5≦0.05. As fixed factors were analyzed percentage of CDs and presence or absence of antimicrobial volatile.

The characterization of the biodegradable active film was carried out as follows. With respect to barrier properties, developed PLA sheets showed almost same CO₂, and O₂ permeabilities than PS sheets and higher than those showed by PET (e.g., see Table III, below). Water vapor permeability of plain PLA sheets was about 10 times higher than that for PS and PET. Therefore, this biodegradable material may be adequate as packaging material for fresh products with high respiration rate such as strawberries, broccoli, asparagus and mushrooms. CO₂, O₂ and water permeability of PLA sheets were increased when the percentage of β-CDs in the mixture was increased. The highest increase in permeability was observed for oxygen. The presence of the volatile may affect the permeability of three gases because lower permeability was observed when the volatile was present, although no significant differences were observed when the statistical analysis was done.

TABLE III
Permeability [10⁻¹⁷ kg/m/m²/s/pa]

| Sample Code | Water | CO₂ | O₂ |
|---|---|---|---|
| PS | 110¹⁰ | 15.5¹⁰ | 2.7¹¹ |
| PET | 670¹² | 0.17¹² | 0.02¹² |
| PLA | 2954 ± 120 a | 32 ± 7 a | 6 ± 0 a |
| PLA 15% BCD | 3875 ± 560 b | 203 ± 57 a | 270 ± 83 a |
| PLA 30% BCD | 4214 ± 263 bc | 204 ± 74 a | 1615 ± 771 b |
| PLA 15% BCD2EH | 3597 ± 349 b | 112 ± 17 a | 247 ± 49 a |
| PLA 30% BCD2EH | 3879 ± 630 b | 199 ± 83 a | 1808 ± 676 b |

The a, b and c mean significant differences among the PLA samples was probably due to both different percentages of CDs (0, 15 and 30%) and the absence or presence of the antifungal volatile (CDs or ICs, respectively)

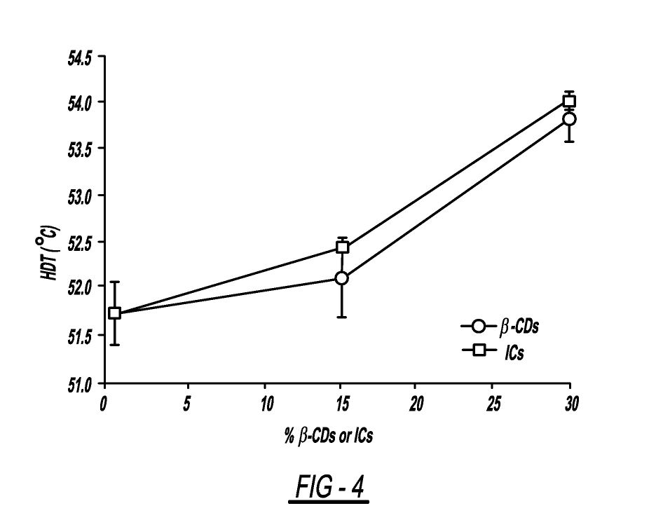

With respect to mechanical properties, the different polymers showed different mechanical response to the addition of β-CDs. PET and PLA presented increased loss and storage modulus while PS modulus didn't change. The different sheets showed different loss and storage modulus depending on the concentration of β-CD or ICs loaded (e.g., see Table IV, below). The presence of antifungal volatile reduced the increase of both moduli. The PLA HDT was slightly increased when loaded with the CDs (e.g., see FIG. 4). Maximum increase was observed for the antifungal sheets.

TABLE IV

| | | Storage Modulus |
|---|---|---|
| Sample Code | Loss Modulus (MPa) | (MPa) |
| PET | 303 ± 28 a | 1919 ± 203 a |
| PET 15% BCD | 460 ± 21 b | 2214 ± 13 b |
| PS | 419 ± 22 a | 1954 ± 103 a |
| PS 15% BCD | 465 ± 25 a | 2173 ± 98 a |
| PLA | 641 ± 16 a | 3025 ± 87 a |
| PLA 15% BCD | 712 ± 70 b | 3606 ± 78 b |
| PLA 30% BCD | 725 ± 30 b | 3708 ± 139 b |
| PLA 15% BCD2EH | 609 ± 16 a | 3265 ± 75 a |
| PLA 30% BCD2EH | 712 ± 27 b | 3278 ± 105 a |

The a and b mean significant differences among polymeric samples was probably due to both different percentages of CDs (0, 15 and 30%) and the absence or presence of the antifungal volatile (CDs or ICs, respectively)

With respect to physical properties, the different polymers showed different physical responses to the addition of β-CDs. Both ICs and β-CDs increased PLA crystallinity (e.g., see FIG. 1a). However, the addition of β-CDs. Did not increase the crystalline level of PET (e.g., see FIG. 1b). Therefore, β-CDs or ICs could function as new and effective nucleating agents for PLA.

Because PLA crystallinity is not modified when β-CDs are carrying an antifungal volatile, it could be supposed that ICs with different chemical volatile compounds such as but not limited to cinnamic acid, 1-methylcyclopropene, isoprene, terpenes as well as any volatile organic compounds (VOCs) could be used as antimicrobial and the CD as nucleating agents. A list of other possible antimicrobial compounds include, without limitation, 2-nonanone, cis-3-hexen-1-ol, methyl jasmonate, acetaldehyde, benzaldehyde, propanal, butanal, (E)-2-hexenal, hexanal, ethanol, acetic acid, allyl-isothiocyanate (AITC), thymol, eugenol, citral, vanillin, trans-cinnamaldehyde, cinnamic acid, salycilic acid, furfural, β-ionone, 1-nonanol, nonanal, 3-hexanone, 2-hexen-1-ol, 1-hexanol, and/or the like.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A crystalline polymeric material, comprising:
a polymeric resin; and
a nucleating agent incorporated into the polymeric resin, wherein the nucleating agent is operable to impart at least partial crystallinity to the polymeric resin.

2. The invention according to claim 1, wherein the crystalline polymeric material provides anti-microbial activity.

3. The invention according to claim 1, wherein the polymeric resin includes polylactic acid.

4. The invention according to claim 1, wherein the nucleating agent includes a cyclodextrin.

5. The invention according to claim 1, wherein the nucleating agent includes a β-cyclodextrin.

6. The invention according to claim 1, wherein the nucleating agent includes an inclusion complex.

7. The invention according to claim 1, wherein the nucleating agent includes an inclusion complex, wherein the inclusion complex includes a cyclodextrin having a volatile compound associated therewith.

8. The invention according to claim 1, wherein the nucleating agent includes an inclusion complex, wherein the inclusion complex includes a β-cyclodextrin having a volatile compound associated therewith, wherein the volatile compound is any of acetaldehyde, 2E-hexenal, or hexanal.

9. The invention according to claim 1, wherein the nucleating agent includes an inclusion complex, wherein the inclusion complex includes a β-cyclodextrin having a volatile compound associated therewith, wherein the volatile compound is selected from the group consisting of cinnamic acid, 1-methylcyclopropene, isoprene, terpenes, 2-nonanone, cis-3-hexen-1-ol, methyl jasmonate, acetaldehyde, benzaldehyde, propanal, butanal, (E)-2-hexenal, hexanal, ethanol, acetic acid, allyl-isothiocyanate (AITC), thymol, eugenol, citral, vanillin, trans-cinnamaldehyde, cinnamic acid, salycilic acid, furfural, β-ionone, 1-nonanol, nonanal, 3-hexanone, 2-hexen-1-ol, 1-hexanol, and combinations thereof.

10. The invention according to claim 1, wherein the crystalline polymeric material provides anti-fungal activity.

11. The invention according to claim 1, wherein the crystalline polymeric material is incorporated into packaging for fresh produce.

12. The invention according to claim 1, wherein the crystalline polymeric material has a degree of crystallinity in the range of about 1.5% to about 18%.

13. A crystalline polymeric material, comprising:
a polylactic acid resin; and
a cyclodextrin incorporated into the polymeric resin, wherein the cyclodextrin is operable to impart at least partial crystallinity to the polymeric resin;
wherein the crystalline polymeric material provides anti-microbial activity.

14. The invention according to claim 13, wherein the nucleating agent includes a cyclodextrin.

15. The invention according to claim 13, wherein the cyclodextrin includes a volatile compound associated therewith to form an inclusion complex.

16. The invention according to claim 13, wherein the cyclodextrin includes a β-cyclodextrin having a volatile compound associated therewith to form an inclusion complex, wherein the volatile compound is any of acetaldehyde, 2E-hexenal, or hexanal.

17. The invention according to claim 13, wherein the cyclodextrin includes a β-cyclodextrin having a volatile compound associated therewith to form an inclusion complex, wherein the volatile compound is selected from the group consisting of cinnamic acid, 1-methylcyclopropene, isoprene, terpenes, 2-nonanone, cis-3-hexen-1-ol, methyl jasmonate, acetaldehyde, benzaldehyde, propanal, butanal, (E)-2-hexenal, hexanal, ethanol, acetic acid, allyl-isothiocyanate (AITC), thymol, eugenol, citral, vanillin, trans-cinnamaldehyde, cinnamic acid, salycilic acid, furfural, β-ionone, 1-nonanol, nonanal, 3-hexanone, 2-hexen-1-ol, 1-hexanol, and combinations thereof.

18. The invention according to claim 13, wherein the crystalline polymeric material provides anti-fungal activity.

19. The invention according to claim 13, wherein the crystalline polymeric material is incorporated into packaging for fresh produce.

20. The invention according to claim 13, wherein the crystalline polymeric material has a degree of crystallinity in the range of about 1.5% to about 18%.

21. A crystalline polymeric material, comprising:
a polylactic acid resin; and
a β-cyclodextrin incorporated into the polymeric resin, wherein the β-cyclodextrin is operable to impart at least partial crystallinity to the polymeric resin;
wherein the crystalline polymeric material provides anti-microbial activity.

22. The invention according to claim 21, wherein the β-cyclodextrin includes a volatile compound associated therewith to form an inclusion complex.

23. The invention according to claim 21, wherein the volatile compound is selected from the group consisting of cinnamic acid, 1-methylcyclopropene, isoprene, terpenes, 2-nonanone, cis-3-hexen-1-ol, methyl jasmonate, acetaldehyde, benzaldehyde, propanal, butanal, (E)-2-hexenal, hexanal, ethanol, acetic acid, allyl-isothiocyanate (AITC), thymol, eugenol, citral, vanillin, trans-cinnamaldehyde, cinnamic acid, salycilic acid, furfural, β-ionone, 1-nonanol, nonanal, 3-hexanone, 2-hexen-1-ol, 1-hexanol, and combinations thereof.

24. The invention according to claim 21, wherein the crystalline polymeric material provides anti-fungal activity.

25. The invention according to claim 21, wherein the crystalline polymeric material is incorporated into packaging for fresh produce.

26. The invention according to claim 21, wherein the crystalline polymeric material has a degree of crystallinity in the range of about 1.5% to about 18%.
